(19) United States
(12) Patent Application Publication
(10) Pub. No.: US 2004/0162719 A1
(43) Pub. Date: Aug. 19, 2004

(54) Interactive electronic publishing

(76) Inventor: Timothy Patrick Bowyer, Applecross (AU)

Correspondence Address: Tim Bowyer, 17 Nisbet Road, Applecross, 6153, AU

(21) Appl. No.: 10/476,507

(22) PCT Filed: Apr. 26, 2002
(86) PCT No.: PCT/AU02/00514

(30) Foreign Application Priority Data
May 11, 2001 (AU) PR 4945
May 14, 2001 (AU) PR 4974
May 21, 2001 (AU) PR 5095
Aug. 13, 2001 (AU) PR 6966
Sep. 4, 2001 (AU) PR 7434

(51) Int. Cl. G06F 17/20

(52) U.S. Cl. 704/1

(57) ABSTRACT

A method of interactive electronic publishing permitting instantaneous conversion of all kinds of text to speech, and of musical score to music, and the creation of the instantaneous effect of animation, all by the operations of a mouse or other interactive device. No autonomous plug-in applications are required. The sounds and images concerned are pre-recorded and edited to minimize file sizes, and pre-loaded before being played in response to mouse actions. In the case of images, the animation effect is achieved by using existing swap-image techniques but using pre-filmed and edited images created for animation purposes. In the case of sounds, existing mouse-over techniques are used but with sounds which make audible the text or animation concerned. In the preferred embodiment of the invention, sounds and images are incorporated into a button and published as a movie with sounds in mp3 format.

Kindly note that throughout this description we use the word “text” to include musical and scientific and mathematical annotation, including for example musical scores and scientific formulae.

### 1 TECHNICAL FIELD

This invention relates to the electronic publication, online or offline, of sounds, images, and all kinds of text, using a mouse or other device that allows interaction between the audience and the material.

### 2 BACKGROUND ART

Until now interactivity in electronic media has been limited to:

2.1 clicking on a word or image to go to a new location, often with a significant delay;

2.2 mousing over text or a button to hear an isolated sound or to see a still image;

2.3 clicking on an object only to then have to wait while a plug-in application starts up to play a sound or movie file, often of poor quality and/or slow to load;

2.4 swapping an image for another by mousing over it but without any cinematic effect of movement or transformation being associated with this interactive exchange of images.

So for example, with electronically published language or literacy learning materials, in order to hear a text spoken, even of only one word, learners must click on the text or on a button beside it and then wait while a plug-in application such as Real Player starts up, loads the sound file and plays it. It has not until now been possible for learners to hear a written text instantly converted to speech, other than by text-to-speech synthesis, which remains error-prone, robotic-sounding, and only available in a limited number of languages and accents. This has seriously impeded the development of electronic-format language and literacy acquisition.

Similarly with images, interactivity has not until now been accompanied by animation. Even online advertisements have remained interactively silent and have limited their interactivity to clicking on a link, despite making some use of animation by means of swap-image techniques. One reason for this may have been the priority need to minimize loading times and therefore file sizes, particularly before (A)DSL became widely available.

### 3 DISCLOSURE OF THE INVENTION

This invention uses existing technology in hitherto unused ways, with some refinement of the processes involved, to allow greater interactivity between electronic audiences and published material than has hitherto been possible. Existing mouse-over techniques, referred to by Macromedia as mouse “behaviours” and “actions”, are used, but with extended and edited pre-recorded sounds and pre-filmed images selected to represent a published text or a planned interactive cinematic event. Texts and images are converted into “buttons” which bear no resemblance to buttons but merely use the technology hitherto applied to buttons. The pre-recorded sounds are no longer merely the short, isolated sounds associated with mousing over a button or similar object, but are sounds which are the audio representation of a given text, or which accompany a swap-image effect in the manner that a sound track accompanies a movie, enhancing the representation of reality. The pre-filmed images are no longer isolated still images but come in pairs or series designed to create the illusion of movement or transformation. This greater data-load in turn requires some refinement in terms of editing and optimisation of the mouse-over effect, optionally the use of the mp3 format for sound, and other compression techniques as described below. The advent of (A)DSL has also made this invention a more accessible one. All of this enables audiences to:

3.1 Convert texts of all kinds into their audio equivalents, including extended human speech, merely by mousing over the text or what appears to be text.

3.2 Experience the illusion of animation by means of a swap-image or similar process, as in a movie projector. But in this case the movie projector is hand-cranked by the audience itself, by means of the mouse or a comparable device.

### 4 APPLICABILITY

Applications include:

4.1 Language learning: merely by passing their mouse over words or phrases, learners can instantly hear them and control the sequence and speed of their delivery. The quality of the speech is natural, authentic and with correct intonation. Authentically accented, natural-speed speech can thus be studied by learners at their own pace, with the speech broken up into natural breaks of phrases or individual words or phonemes, and such speech can be heard with more immediacy and less effort than has previously been possible. No autonomous plug-in application is required.

4.2 Early Learner reading skills: children can now learn to read faster, more enjoyably and at a younger age than was previously possible, because they can mouse over text to hear it instantly, at their own chosen pace, stopping and repeating whenever they wish. Even a two-year-old has the motor skills to move a mouse over large-font text.

4.3 Sheet music: as you mouse over the notes, you hear them play, while a movie may simultaneously appear beside the score, showing the fingers appearing to move over the correct stops of a clarinet in synchrony with the playing of the notes, thus making the learning of music both more efficient and more intuitive than has hitherto been possible. Music can be composed by dragging and dropping notes onto the score, (or by typing them onto the score with an appropriately designed virtual keyboard), and instantly played back merely by mousing over the result.

4.4 Interactive movies: the audience is given the illusion of interacting with people and objects by, for example, mousing over a part of someone's body to elicit sounds and/or the illusion of movement by the depicted person. These movements are depicted by adding or swapping successive images as the mouse passes over or clicks on a given image, in the same way that successive still photos, when rapidly swapped, create the illusion of movement or transformation in a movie projector. Online banner adverts can now react instantly to being moused over—a lady turns her head upon being moused over, smiles, and says “you can click on me if you like”. A person appears to be pushed by the mouse; a car appears to have been started by a mouse cursor in the guise of a key.

In essence, therefore, this invention represents a new way of communicating using existing technology, much as the movie projector used existing inventions to create the illusion of movement from still images. Instant and effortless high-quality text-to-sound conversion, and the illusion of live interaction with people and objects, are the outcomes of this invention.

### 5 MODE FOR CARRYING OUT THE INVENTION

5.1 Overview

Firstly, one or more images and/or sounds are created. The image is created and edited using a graphics program such as Paint Shop Pro, while the sound is recorded and edited using an audio program such as Goldwave 4.25. The image or sound must be edited expertly, to minimize file sizes while maintaining good quality. This image or sound is then filed in a publishing program such as Macromedia's Dreamweaver and/or Flash and uploaded onto the internet or onto a CD or other storage device.

On the page that is to accommodate the mouse-over behaviours, using a program such as Dreamweaver, a behaviour is attached to each object to be moused over, so that all of the images and sounds referred to above are pre-loaded when the page is first opened, and when a given object is moused over these sounds and images are instantly played or displayed and/or swapped. The mouseover interactions can also be created in a program such as Macromedia Flash; in this case file sizes can be smaller and/or the quality higher, particularly with sound files because Flash uses mp3 format, which allows greater compression than the wav format.

Timelines or a comparable device can also be used in the design to change the sounds and/or images that appear in accordance with the amount of time that has passed since the page was first opened, further enhancing the illusion of interactivity.

5.2 Specific Modes Available

5.2.1 Mouse over an image to produce a sound. For example:

Using Goldwave 4.25 and a computer with a microphone, taking care to record without distortion or extraneous sounds, the sound “the” is recorded as it would be naturally spoken. The sound file size is then reduced to a practical one in terms of quality versus download time by cropping it to the maximum using the same program, and by reducing the frequency range, for example from the default 22,050 khz to 11,025 khz 8-bit mono, yielding a .wav file of about 3 kb. This file is saved and uploaded to a CD or website.

Using a graphics program such as Corel PhotoPaint 4.0, a new picture measuring 100 pixels wide by 20 high is created. The word “the” is typed into this picture, and the resulting image is stored as a gif file. The total number of pixels in the file is adjusted using the same program (for example by re-sizing the image) to achieve a balance between acceptable image quality and acceptable down-load time. An online Gif Reduction service should also be used to reduce the size of the file. This file is saved and uploaded to a CD or website.

A page within which to play the sound is now created, and the image created is now inserted onto the page at the desired location. The image is now selected, and a behaviour is attached to the image as follows: the behaviour is to control sound; the specific instruction, or action, is to play the .wav file that has been created, and the event specified is “on mouse over”. The pre-load option is selected if it is offered, but it operates by default in some programmes. The page is now saved and published.

The result is that the sound “the” is pre-loaded and is heard when you mouse over what appears to be the text word “the” but is in fact an image.

5.2.2 Mouse over text to produce a sound. For example:

As in 5.2.1 above, except that no image is created. Instead, text is typed directly into the page, and then each sound to be played is attached to a given piece of text as in 1 above. For example, the sentence “Hello, my name's Tim, what's yours?” is recorded as one complete sentence. The file size is reduced as in 5.2.1 above. Natural breaks are chosen within the sentence, so that it is broken up into the following three new .wav files: Hello, and my name's Tim, and what's yours. These files are stored and uploaded as in 5.2.1 above.

“Hello, my name's Tim, what's yours?” is typed directly into the page desired at the desired location and with the desired formatting. The word “Hello” is selected and a behaviour is attached to it as above in 5.2.1, but in this case the file attached is the .wav file containing the sentence fragment “Hello” The same is done for the fragments “my name's Tim” and “what's yours”.

The result is at that as you mouse over the text, the phrases are spoken at natural speed with natural fluency. Their sequential delivery can be paused merely by halting the mouse, or even reversed by moving the mouse backwards. Each phrase can be repeated by moving the mouse over the same phrase again and again. The speed of delivery of the sentence fragments varies with the speed of movement of the mouse over the written sentence.

5.2.3 Mouse over an image to produce an image. For example: as above, but instead of or in addition to producing a sound, an image replaces another almost identical image when the first image is moused over. So for example a photograph of a young lady in a jacket is replaced as if by magic, using the same techniques described in 1 and 2 above, by an identical photograph of the young lady with her jacket unbuttoned, merely by mousing over her jacket button. This is achieved by attaching a behaviour (such that an image of the lady with her jacket unbuttoned replaces the original image on mouse over, mouse out or, if preferred, mouse click) to a hotspot that is drawn solely around the jacket button on the image map using a program such as Dreamweaver 4. A female voice saying “Did you do that?” could accompany this behaviour using the procedure described in 1 above. The interactive, cinematic illusion is that the audience itself has voluntarily unbuttoned the young lady's jacket.

Additional Explanatory Notes to 5.2:

Note 1: In 5.2.3 above, the behaviour attached is a ‘swap image’ or comparable command which achieves the effect of displaying an image in the manner described above. The file attached is an image file, edited as described above in 1.3, such as a jpeg,jpg or gif file (any of these formats are also acceptable for the image-to-sound process described in 5.2.1 above). The event specified is for example “onMouseout” or a comparable event which achieves the overall effect of one image being rapidly replaced by another to achieve the illusion of movement. The specific behaviours/instructions/actions/events may be varied according to the requirements of each context. Instead of “onMouseover”, “onMouseout” or “onClick” may be preferable; for example, it may be felt that a click of the mouse, rather than a mere mouse-over movement, is a more appropriate way of releasing the young lady's bikini top fastener. The illusion achieved remains essentially the same. Similarly, a different image command such as “swap image restore” may be desired in addition to “swap image” in order to accomplish a given illusion. By creating a whole sequence of swap-image effects, extended interactive animation is produced.

Note 2: Either of specific modes 5.2.1 and 5.2.2, alone or with technique 5.2.3, can be used to play sheet music. In the case of mode 5.2.1, an image is made of the score and a sound file is attached to each of a series of hotspots drawn around each note, trill or arpeggio. In the case of mode 5.2.2, a keyboard is used where the usual ASCI characters are replaced by notes and other musical symbols so that music can be written directly from the computer keyboard, or from a virtual keyboard-like device (such as those already in use in programmes such as NJ Star for transcribing non-Roman characters with Roman-character keyboards), as though it were text. Sound files are then attached as in 5.2.2 above, either to single notes, or to clusters of notes (Eg a trill or an arpeggio) or musical phrases of any chosen duration. These can then be played back merely by mousing over the score; each note will have the correct pitch and duration (assuming the recorded sound was correct), while the tempo can be determined by the movement of the mouse. Mode 5.2.3 can also be used to create an illusion of movement of fingers over a clarinet, for example, as the notes are moused over, to illustrate the correct fingering.

Note 3: Two additional techniques which facilitate the cinematic effect described above, and some notes on mouse use:

3.1 Vectoring: vectoring can be used as a strategy for improving quality and/or reducing file sizes in animation sequences by reducing the number of images needed to achieve the cinematic effect The process is well-known and documented in programs such as Macromedia Flash, and is used here simply as an optional additional facilitator to enhance the illusory effect.

3.2 Databases: (remote) databases can be used in the conventional way in combination with the mouseover procedures described above, in order to provide a range of plot options which may be triggered in whatever sequence and/or combination the publisher (and later the audience) chooses. The database may contain images, text, and sounds. For example, in the mouseover music example described above, a range of musical sounds at all useful pitches and note lengths is stored in a database, together with a range of locations on a musical score to cover the whole useful scale of musical sounds from highest to lowest, and a collection of images to represent all the musical symbols used in sheet music. This database can then be used interactively to compose music by dragging and dropping musical symbols onto a score and mousing over it to hear the result—a kind of musical autocad.

3.3 Mouse use: mouseovers are not the only action available to audiences. Drag-and-drop, for example, is a powerful assistant in the creation of the illusion of interactive animation. Also the mouse can be represented on-screen by any image. So, for example, in the bikini example previously cited, the top can be dragged off the lady and dropped on the floor, using the image of a hand rather than of a pointer, and using a vectored movie which is triggered by the drag-and-drop action, to enhance the illusion of movement, creating a ‘ghost in the machine’ effect.

5.3 Preferred Mode for Carrying Out the Invention

The precise techniques required to achieve the effects described above will differ with the proprietary software used; in Macromedia Flash, for example, ActionScript will be used to define the behaviours (“actions”) and the sound files will be in mp3 format; but the essence of the invention as described above remains the same. We define this as our “preferred mode” because it currently offers the best technical options in terms of files sizes, quality of sound and images, and tools such as vectoring. Here is an example of the invention using Flash, and using the specific image-to-sound mode to teach pronunciation:

First, the page is created as described previously, using Dreamweaver, but without the interactive mouseover images and their related sounds. Now for each sound, a Flash movie is created measuring just 120 by 30 pixels. In order to do this, the following steps are required:

5.3.1 The sound file in wav format must be edited before it is imported into Flash to minimize its size (by cropping) and to optimize the sound quality. There is generally some loss of higher frequency sounds in the process of converting to mp3 format, so the frequency response should be compensated using a virtual equaliser such as Goldwave 4.25. The volume should also at this stage be clipped to ensure that there will be no distortion at higher volume levels when the sound is converted to mp3 format.

5.3.2 Open a new Flash movie. Go to Modify—Movie and set size to 120×30 px. Insert New Symbol, choosing “button”, and import into this button the gif graphic “should.gif”, which has previously been reduced to the minimum practical size. This graphic measures 100×20 px, and displays the word “should”. Note that the rollover technique works more reliably in Flash if the graphic is smaller than the stage. Also the gif will sometimes be distorted if it is converted to a symbol after being imported, rather than being imported directly into the new symbol which has been created first.

5.3.3 Double-click on the image “should” in the library window and in Layer 1 click once in the “Over” frame. Insert keyframe. Now import the prevously edited wav file “should”, and in the sound panel select it. Return to the main movie and drag the image of the symbol from the library window onto centre-stage.

5.3.4 Control—Test Movie. File—Export Movie—protect from import. The movie has now been created as a swf file.

5.3.5 In Dreamweaver 4, Insert—Media—Flash to insert the above swf file into the table beside other examples of the same sound: “good, would,” etc. The resulting html file is ready to publish, and the sound “should” will be heard on mousing over the button which appears to be the text “should”, but is in fact an image imported into a button.

### 6 DEMONSTRATION OF THE INVENTION

A demonstration of the invention in all of its Modes can now be seen and heard at www.fonetiks.org/demo.html—please allow up to 3 minutes to load. Please note that the Flash player application is required (most computers already have it), and that the non-Flash examples may not work on a Macintosh computer.

Sample 1: text-to-speech and image: mouse over the text

Sample 2: image-to-speech (Flash): mouse over the “text”

Sample 3: animation: use the mouse to cut the ribbon

Sample 4: animation: mouse over to make the baby finish his food

Sample 5: music-to-sound: mouse over the notes to play the score

Sample 6: text-to-speech and image: mouse over the formula to hear its verbalization

What is claimed is:

1 A method of electronic publishing which provides instantaneous text-to-speech conversion, in quantities ranging from single phonemes to extended text, where “text” means all kinds of text including scientific and mathematical notation, by means of a mouse or other device that allows interaction between the audience and the material, whereby pre-recorded and edited human speech is used to represent the published text, which is itself specially treated as described in the Description in order to produce the said instantaneous conversion.

2 A method of electronic publishing which provides instantaneous musical score-to-music conversion, in quantities ranging from a single note to extended pieces of music, by means of a mouse or other device that allows interaction between the audience and the material, whereby pre-recorded and edited sounds are used, to represent the published score, which is itself specially treated as described in the Description in order to produce the said instantaneous conversion.

3 A method of electronic publishing which provides a movie projector effect, giving an effect of animation which is triggered by the audience itself through the medium of a mouse or other device that allows interaction between the audience and the material, whereby pre-edited images are swapped in rapid succession in response to the operation of the mouse, having been specially treated as described in the Description in order to produce the said effect.

4 The method of claim 1, wherein text is converted to one or more images.

5 The method of claim 1, wherein text is incorporated in one or more “buttons” (in the sense of “buttons” that is used by Macromedia).

6 The method of claim 1, wherein sound is converted to mp3 format.

7 The method of claim 2, wherein the musical notation is converted into one or more images.

8 The method of claim 2, wherein the musical notation is incorporated in one or more “buttons” (in the sense of “buttons” that is used by Macromedia).

9 The method of claim 2, wherein sound is converted to mp3 format.

10 The method of claim 3, wherein the images are incorporated within one or more “buttons” (in the sense of “buttons” that is used by Macromedia).

11 The method of claim 3, wherein sound is also triggered by the operation of the mouse to give the effect of a talking movie controlled by the mouse.
